(19) United States
(12) Patent Application Publication
(10) Pub. No.: US 2008/0074888 A1
(43) Pub. Date: Mar. 27, 2008

(54) LIGHT EMITTING DIODE HAVING REFLECTIVE MEMBER AND METHOD FOR MAKING THE SAME

(75) Inventor: SHAO-HAN CHANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/611,465

(22) Filed: Dec. 15, 2006

(30) Foreign Application Priority Data
Sep. 21, 2006 (CN) 200610200888.9

(51) Int. Cl. F21V 5/00; F21V 7/00

(52) U.S. Cl. 362/327; 362/308

(57) ABSTRACT

An exemplary light emitting diode includes a light output unit, an optical lens, and a reflective resin member. The optical lens is mounted on the light output unit. The optical lens includes a light input surface facing the light output unit, a top interface distal from the light input surface, and a light output surface generally between the light input surface and the top interface. The reflective resin member is formed on the top interface of the optical lens. Methods for making the light emitting diode are also provided.

### BACKGROUND OF THE INVENTION

1. Field of the Invention

The present invention relates to light emitting diodes; and more particularly to a side-emitting light emitting diode typically employed in a direct type backlight module of a liquid crystal display, and method for making the light emitting diode.

2. Discussion of the Related Art

In a liquid crystal display device, liquid crystal is a substance that does not itself radiate light. Instead, the liquid crystal relies on light received from a light source in order to provide displaying of images and data. In the case of a typical liquid crystal display device, a backlight module powered by electricity supplies the needed light.

Typically, a light source of a backlight module is one of the following two types: a cold cathode fluorescence lamp (CCFL), or a light emitting diode (LED). Disadvantages of a CCFL include high energy consumption, low optical uniformity, and poor purity of white light. In addition, after being repeatedly used over time, a brightness of the CCFL becomes degraded and a color of light emitted by the CCFL tends to shift. In general, the service life of a CCFL is about 15,000 to 25,000 hours. Furthermore, a CCFL only covers 75 percent of color space as defined by the National Television Standards Committee (NTSC). Therefore, using a CCFL cannot satisfy the requirements for a high quality color liquid crystal display. Unlike CCFLs, high powered LEDs can cover as much as 105 percent of color space as defined by the NTSC. In addition, these LEDs have other advantages such as low energy consumption, long service life, and so on. Therefore, high power LEDs are better suited for producing high quality color liquid crystal displays.

FIG. 6 illustrates a conventional backlight module 10 using a plurality of LEDs 12. The backlight module 10 includes a frame 11, an optical plate 14, and the LEDs 12. The frame 11 includes a base 112, and a plurality of sidewalls 114 extending from a periphery of the base 112. Top portions of the sidewalls 114 cooperatively form an opening 116 therebetween. The LEDs 12 are regularly arranged on the base 112 of the frame 11. The optical plate 14 is disposed on the frame 11 over the opening 116. Light rays emitted by the LEDs 12 are diffused in the optical plate 14, so that substantially planar light is outputted from the optical plate 14.

Each LED 12 includes a light output unit 121, and an optical lens 122 coupled to the light output unit 121. The optical lens 122 includes a light input surface 1221, a top interface 1222 opposite to the light input surface 1221, and a peripheral light output surface 1223 generally between the light input surface 1221 and the top interface 1222. Light rays emitted by the light output unit 121 enter the optical lens 122 through the light input surface 1221 and transmit to the top interface 1222. Many or most of the light rays undergo total internal reflection at the top interface 1222, and then exit the optical lens 122 through the light output surface 1223.

However, a significant proportion of the light rays still escape from the optical lens 122 through the top interface 1222. This would ordinarily cause a bright area to occur in the optical plate 14 above the LED 12. In order to prevent this problem, the backlight module 10 further includes a transparent plate 13 disposed between the optical plate 14 and the LEDs 12. The transparent plate 13 defines a plurality of reflective layers 131 on a bottom thereof. The reflective layers 131 are positioned in one-to-one correspondence with the LEDs 12. However, precisely positioning the transparent plate 131 according to the LEDs 12 can be very problematic and troublesome, due to the small size of the LEDs 12. In addition, the transparent plate 13 makes the backlight module 10 rather heavy, and adds to manufacturing costs.

What is needed, therefore, is a light emitting diode and a method for making a light emitting diode which can overcome the above-described shortcomings.

### SUMMARY

In one aspect, a light emitting diode according to a preferred embodiment includes a light output unit, an optical lens and a reflective resin member. The optical lens is mounted on the light output unit. The optical lens includes a light input surface facing the light output unit, a top interface distal from the light input surface, and a light output surface generally between the light input surface and the top interface. The reflective resin member is formed on the top interface of the optical lens.

In another aspect, a method for making the above-described light emitting diode according to a preferred embodiment includes steps of: providing an optical lens and a reflective resin paste, the optical lens including a light input surface, a top interface opposite to the light input surface, and a light output surface interconnecting with the light input surface and the top interface; depositing the reflective resin paste onto top interface of the optical lens; solidifying the reflective resin paste to form a reflective resin member on the top interface; providing a light output unit including a light-emitting semiconductor; and coupling the optical lens with the reflective resin member to a light output unit, such that the light input surface of the optical lens faces the light-emitting semiconductor.

In still another aspect, a method for making the above-described light emitting diode according to another preferred embodiment includes steps of: coupling an optical lens to a light output unit to form a subassembly, the optical lens including a light input surface, a top interface distal from the light input surface, and a light output surface generally between the light input surface and the top interface; depositing the reflective resin paste on the top interface of the optical lens of the subassembly; and solidifying the reflective resin paste to form the reflective resin member on the top interface of the optical lens of the subassembly.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present light emitting diode and method for making the light emitting diode. Moreover, in the drawings, like reference numerals designate corresponding parts throughout the several views, and all the views are schematic.

FIG. 1 is a side, cross-sectional view of a light emitting diode having an optical lens according to a first preferred embodiment of the present invention.

FIG. 2 is a side, cross-sectional view of a light emitting diode according to a second preferred embodiment of the present invention.

FIG. 3 is a side, cross-sectional view of a light emitting diode according to a third preferred embodiment of the present invention, the light emitting diode including an optical lens and a reflective resin layer.

FIG. 4 is a side, cross-sectional view of the optical lens of FIG. 3 with a mass of reflective resin paste deposited on a top interface thereof, according to one stage in an exemplary method for making the light emitting diode of FIG. 3.

FIG. 5 is similar to FIG. 4, but showing the mass of reflective resin paste changed into a preform of the reflective resin layer by a pressing member, according to a subsequent stage in the exemplary method for making the light emitting diode of FIG. 3.

FIG. 6 is a side, cross-sectional view of a conventional backlight module having a plurality of light emitting diodes.

### DETAILED DESCRIPTION OF THE PREFERRED EMBODIMENTS

References will now be made to the drawings to describe preferred embodiments of the present light emitting diode and method for making the light emitting diode, in detail.

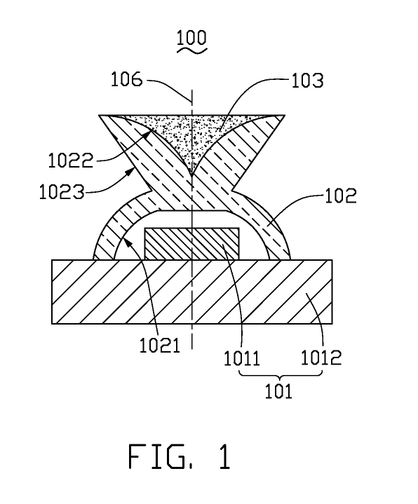

Referring to FIG. 1, a light emitting diode 100 in accordance with a first preferred embodiment of the present invention is shown. The light emitting diode 100 includes a light output unit 101, an optical lens 102, and a reflective resin member 103. The light emitting diode 100 defines a central vertical axis 106, which passes through centers of the light output unit 101 and the optical lens 102. The light output unit 101 includes a base 1012, and a semiconductor chip 1011 fixed on the base 1012. The semiconductor chip 1011 has a light emitting PN (P-type silicon, N-type silicon) junction. The optical lens 102 includes a light input surface 1021, a top interface 1022 opposite to the light input surface 1021, and a peripheral light output surface 1023 generally between the light input surface 1021 and the top interface 1022. The light input surface 1021 has the shape of a flat-topped dome. The top interface 1022 is funnel-shaped. In the illustrated embodiment, the funnel shape of the top interface 1022 progressively flares out from a bottom of the top interface 1022 to a top of the top interface 1022, with a cross-section of the top interface 1022 taken through the central axis 106 showing two convexities of the top interface 1022.

The reflective resin member 103 is applied on the top interface 1022 of the optical lens 102. The reflective resin member 103 is solidified from a reflective resin paste. The reflective resin paste includes light-curable resin, and pigmented aluminum flakes homogeneously incorporated in the light-curable resin. The pigmented aluminum flakes have high reflectivity. An outer surface (not labeled) of the reflective resin member 103 opposite to the light input surface 1021 is configured to be a flat surface parallel to the base 1012 of the light output unit 101. The optical lens 102 is snap-fitted or otherwise mounted onto the base 1012 of the light output unit 101. Thereby, the light input surface 1021 faces the semiconductor chip 1011, and the light input surface 1021 and the base 1012 cooperate to completely surround the semiconductor chip 1011. Light rays emitted by the light output unit 101 enter the optical lens 102 through the light input surface 1021. The light rays transmit to the top interface 1022. Many or most of the light rays undergo total reflection at the top interface 1022. Other light rays escape from the top interface 1022, and are reflected back into the optical lens 102 by the reflective resin member 103. Finally, all the light rays exit the optical lens 102 through the light output surface 1023.

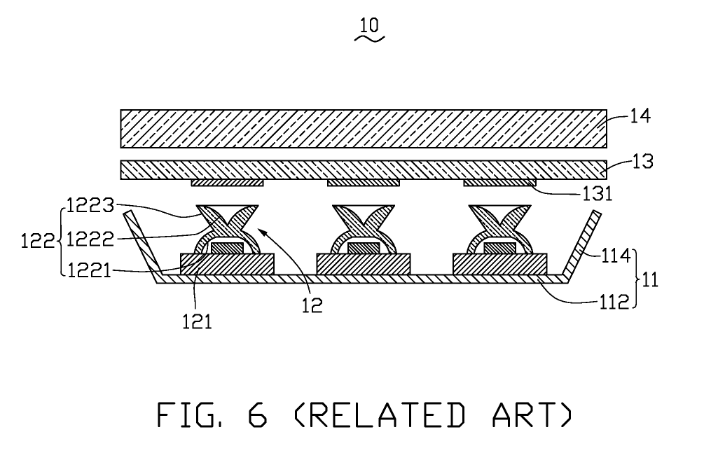

The reflective resin member 103 of the light emitting diode 100 is configured for preventing light that escapes through the top interface 1022 from transmitting to regions above the light emitting diode 100. This enables a significant amount of light rays to output through the light output surface 1023 of the optical lens 102. In addition, when a plurality of the light emitting diodes 100 are applied in a backlight module, a distance from the light emitting diodes 100 to an optical plate may be configured to be very small, with little or no risk of bright dots occurring in the optical plate due to reduced intensity of light between adjacent light emitting diodes 100. Furthermore, when compared with the above-described conventional backlight module 10 (shown in FIG. 6), the backlight module utilizing the present light emitting diodes 100 has a relatively lightweight design because a transparent plate such as the transparent plate 13 is not needed.

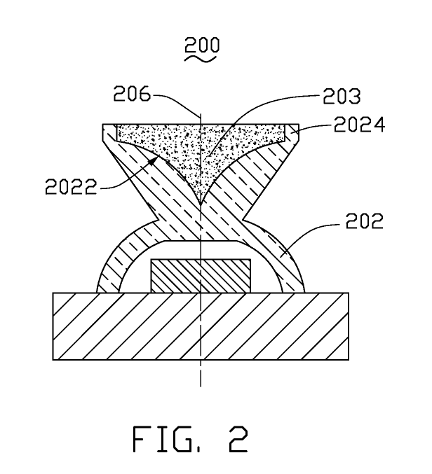

Referring to FIG. 2, a light emitting diode 200 in accordance with a second preferred embodiment of the present invention is shown. The light emitting diode 200 is similar in principle to the light emitting diode 100 of the first embodiment. However, an optical lens 202 of the light emitting diode 200 further includes a flange ring portion 2024 extending up from a flared funnel-shaped portion thereof. The flared funnel-shaped portion and the flange ring portion 2024 cooperatively define a top interface 2022. The top interface 2022 defines a receptacle (not labeled) for receiving a reflective resin member 203. In this embodiment, the reflective resin member 203 completely fills the receptacle. The flange ring portion 204 can help prevent the reflective resin member 203 from detaching from the top interface 2022 of the optical lens 202.

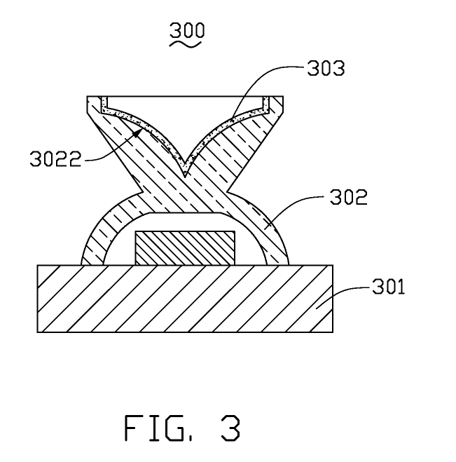

Referring to FIG. 3, a light emitting diode 300 in accordance with a third preferred embodiment of the present invention is shown. The light emitting diode 300 is similar in principle to the light emitting diode 200 of the second embodiment, except that a reflective resin member 303 that covers a funnel-shaped top interface 3022 of the optical lens 302 has a uniform thickness. Therefore, the reflective resin member 303 has a funnel-shaped outer surface corresponding to and distal from the top interface 3022. This configuration means that the reflective resin member 303 has a small volume. Therefore the cost of materials needed to produce the reflective resin member 303 is reduced, and the weight of the light emitting diode 200 is also reduced.

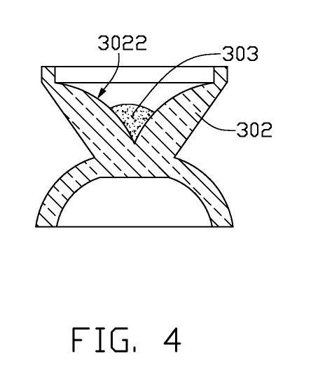

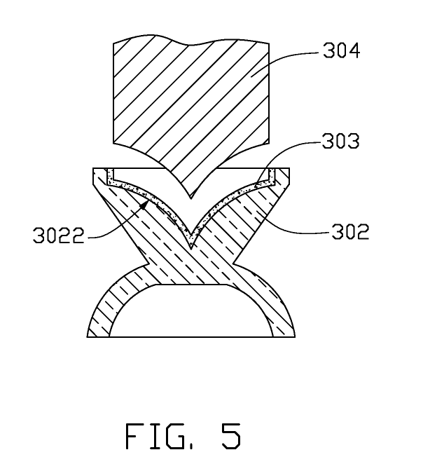

An exemplary method for making the light emitting diode 300 is as follows. Referring to FIG. 4, firstly, an optical lens 302 is provided. Secondly, an amount of reflective resin paste is deposited on the funnel-shaped top interface 3022 of the optical lens 302, for example by an injector. The reflective resin paste includes light-curable resin, and pigmented aluminum flakes homogeneously incorporated in the light-curable resin. The pigmented aluminum flakes have high reflectivity. Thirdly, referring to FIG. 5, a columnar pressing member 304 is provided. The pressing member 304 includes a pressing stamp at an end thereof. A shape of the pressing stamp is generally conical, and matches with the funnel shape of the top interface 3022. The pressing stamp of the pressing member 304 is applied to press the mass of reflective resin paste on the funnel-shaped top interface 3022, so as to obtain a layer of the reflective resin paste that has a uniform thickness. Fourthly, ultraviolet light rays are applied to the reflective resin paste. Thereby, the reflective resin paste is solidified to form the reflective resin member 303 on the top interface 3022 of the optical lens 302. Finally, the optical lens 302 having the reflective resin member 303 is coupled to the light output unit 301 to form the light emitting diode 300.

An exemplary method for making the light emitting diode 200 is similar to the above-described method for making the light emitting diode 300. The main difference is that the third step of using the pressing member 304 is omitted. Instead, the reflective resin paste completely fills up the receptacle of the optical lens 202.

In alternative embodiments of the above-described exemplary methods, the reflective resin paste can include heat-curable resin, and pigmented aluminum flakes homogeneously incorporated in the heat-curable resin. In such embodiments, the reflective resin paste is solidified by way of thermal curing.

Another exemplary method for making the light emitting diode 300 is as follows. Firstly, the optical lens 302 is coupled to the light output unit 301 to form a subassembly. Secondly, an amount of reflective resin paste is deposited on the funnel-shaped top interface 3022 of the optical lens 302 of the subassembly, for example by an injector. The reflective resin paste includes light-curable resin, and pigmented aluminum flakes homogeneously incorporated in the light-curable resin. The pigmented aluminum flakes have high reflectivity. Thirdly, the pressing stamp of the pressing member 304 is applied to press the mass of reflective resin paste on the funnel-shaped top interface 3022, so as to obtain a layer of the reflective resin paste that has a uniform thickness. Finally, ultraviolet light rays are applied to the reflective resin paste. Thereby, the reflective resin paste is solidified to form the reflective resin member 303 on the top interface 3022 of the optical lens 302.

Another exemplary method for making the light emitting diode 200 is similar to the above-described other method for making the light emitting diode 300. The main difference is that the third step of using the pressing member 304 is omitted. Instead, the reflective resin paste completely fills up the receptacle of the optical lens 202.

It is to be noted that the shape of the optical lens is not limited to the above-described embodiments. Other suitable shapes can be configured. Further, in any of the above-described embodiments, a ratio by weight of the pigmented aluminum flakes to the light-curable resin of the reflective resin paste can be configured to obtain a desired light reflection characteristic for the reflective resin member, or be configured to obtain a desired semi-transmission characteristic for the reflective resin member.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A light emitting diode comprising:
a light output unit;
an optical lens mounted on the light output unit, the optical lens comprising:
a light input surface facing the light output unit,
a top interface distal from the light input surface, and
a light output surface generally between the light input surface and the top interface; and
a reflective resin member formed on the top interface of the optical lens.

2. The light emitting diode according to claim 1, wherein the light emitting diode defines a central vertical axis that passes through centers of the light output unit and the optical lens, and the light input surface has the shape of a flat-topped dome.

3. The light emitting diode according to claim 2, wherein the optical lens further comprises a flange ring portion extending up from a flared funnel-shaped portion thereof.

4. The light emitting diode according to claim 1, wherein the top interface is funnel-shaped.

5. The light emitting diode according to claim 4, wherein the reflective resin member fills with the funnel shape top interface.

6. The light emitting diode according to claim 4, wherein the reflective resin member that covers the funnel-shaped top interface of the optical lens has a uniform thickness.

7. The light emitting diode according to claim 1, wherein the reflective resin member is solidified from a reflective resin paste, the reflective resin paste including light-curable resin, and pigmented aluminum flakes homogeneously incorporated in the light-curable resin.

8. A method for making a light emitting diode, comprising:
providing an optical lens and reflective resin paste, the optical lens including a light input surface, a top interface distal from the light input surface, and a light output surface generally between the light input surface and the top interface;
depositing the reflective resin paste onto the top interface of the optical lens;
solidifying the reflective resin paste to form a reflective resin member on the top interface;
providing a light output unit including a light-emitting semiconductor; and
coupling the optical lens with the reflective resin member to the light output unit, such that the light input surface of the optical lens faces the light-emitting semiconductor.

9. The method according to claim 8, wherein the reflective resin paste comprises light-curable resin, and pigmented aluminum flakes homogeneously incorporated in the light-curable resin.

10. The method according to claim 8, further comprising pressing the reflective resin paste deposited on the top interface of the optical lens by using a pressing member, so that the deposited reflective resin paste has a uniform thickness.

11. The method according to claim 8, wherein solidifying the reflective resin paste is performed by one of a thermal solidifying process and an ultraviolet light irradiation process.

12. A method for making a light emitting diode, comprising:
coupling an optical lens to a light output unit to form a subassembly, the optical lens including a light input surface, a top interface distal from the light input surface, and a light output surface generally between the light input surface and the top interface;
depositing the reflective resin paste on the top interface of the optical lens of the subassembly; and
solidifying the reflective resin paste to form the reflective resin member on the top interface of the optical lens of the subassembly.

13. The method according to claim 12, wherein the reflective resin paste comprises light-curable resin, and pigmented aluminum flakes homogeneously incorporated in the light-curable resin.

14. The method according to claim 12, further comprising pressing the reflective resin paste deposited on the top interface of the optical lens by using a pressing member, so that the deposited reflective resin paste has a uniform thickness.

15. The method according to claim 12, wherein solidifying the reflective resin paste is performed by one of a thermal solidifying process and an ultraviolet light irradiation process.
